(19) United States
(12) Patent Application Publication
(10) Pub. No.: US 2013/0201895 A1
(43) Pub. Date: Aug. 8, 2013

(54) Method for Automatic Reconfiguration in a Hierarchical Modulation System

(71) Applicants: Joseph Smallcomb, Lake Worth, FL (US); Paul Krayeski, Wellington, FL (US)

(72) Inventors: Joseph Smallcomb, Lake Worth, FL (US); Paul Krayeski, Wellington, FL (US)

(21) Appl. No.: 13/575,106

(22) PCT Filed: Jan. 26, 2011
(86) PCT No.: PCT/US11/00144

§ 371 Date: Sep. 14, 2012

Related U.S. Application Data
(60) Provisional application No. 61/282,341, filed on Jan. 26, 2010.

(51) Int. Cl. H04L 1/00

(52) U.S. Cl. CPC H04L 1/0041
USPC 370/312

(57) ABSTRACT

A method is provided for enhancing a legacy satellite digital radio audio service (SDARS) by overlaying a hierarchically modulated data stream on a base layer (legacy) data stream to increase the amount of data transmitted in the SDARS system. Using improved (next generation) receiver designs, additional services can be provided to users while existing legacy receivers can continue to receive the services broadcast on the base layer modulated data stream in the legacy system.

### RELATED PATENT APPLICATIONS

This application claims the benefit of U.S. Provisional Application Ser. No. 61/282,341 filed on Jan. 26, 2010, which is hereby incorporated by reference herein in its entirety.

### FIELD OF THE INVENTION

The present application relates to a system and method for providing a plurality of separate data streams onto a single transmitted stream for targeting different receivers, and/or providing different services, and a method for dynamically reconfiguring the parameters of the separate data streams for modifying the services provided thereon without a loss of service.

### BACKGROUND OF THE INVENTION

Satellite radio operators are presently providing digital radio broadcast services covering the entire continental United States and other parts of North America. These services offer approximately 170 channels, of which nearly 75 channels in a typical configuration provide music and the remaining channels offer news, sports, talk and data services. A block diagram of an illustrative satellite digital audio radio service (SDARS) system 10 is depicted in FIG. 1. The illustrative SDARS system is a diversity system in which time, spatial and or code diversity is employed to overcome signal losses. For example, SDARS receivers demodulate and decode broadcast streams from multiple transmission sources such as first and second satellite streams broadcast from first and second satellites for time and spatial diversity purposes and/or terrestrial broadcast streams (e.g., from such terrestrial transmission sources as terrestrial repeaters, paging systems and/or cellular systems) employed to overcome LOS issues and other signal loss issues described below. For example, an SDARS system operated by Sirius XM Radio Inc. includes satellite uplink stations 2a, 2b for transmitting X-band uplinks to two satellites 4, 6 which provide frequency translation to the S-band for retransmission to radio receivers 3 within a coverage area. Radio frequency carriers from one of the satellites 4, 6 are also received by terrestrial repeaters 5. The content received at the terrestrial repeaters 5 is retransmitted at a different S-band carrier to the same receivers 3 that are within their respective coverage areas. These terrestrial repeaters 5 facilitate reliable reception in geographic areas where line of sight (LOS) reception from the satellites 4, 6 is obscured by tall buildings, hills, tunnels and other obstructions. The signals transmitted by the satellites 4, 6 and the repeaters 5 are received by SDARS receivers 3 which can be located in automobiles, in a handheld unit or in stationary units for home or office use. The SDARS receivers 3 are designed to receive one or both of the satellite signals and the signals from the terrestrial repeaters, and combine selected signals or select one of the signals as the receiver output. Thus, the receivers 3 can demodulate, decode and output a selected channel from the received signals even when, for example, a signal dropout has occurred in one of the transmission channels.

In a legacy SDARS system implemented by Sirius XM Radio Inc. described above, the plurality of services are modulated as a base layer using a Quadrature Phase Shift Key (QPSK) modulation technique for the radio frequency carriers of the satellite links, and a multi-carrier modulation technique for the terrestrial links. These base layer modulation techniques can be enhanced to carry additional information by implementing a technique called hierarchical modulation. Hierarchical modulation is a technique for multiplexing and modulating a plurality of data streams into a single data stream by overlaying the additional information onto a base layer.

Some examples of hierarchical modulation schemes on a QPSK waveform are shown in FIG. 2. Constellation (a) illustrates a phase shift keying (PSK) modulation technique to overlay the additional information onto a base layer. In this technique, the received vector is mapped as (BL, OL) where BL indicates the base layer symbols in the transmitted base layer QPSK constellation using 2 input BL bits. The OL bit indicates an overlay symbol when the base layer modulation vector is rotated by a predetermined angle toward either the Q-axis or the I-axis. As shown for example, if the base layer modulation vector is rotated toward the Q-axis, the OL bit is represented by a 1, and if the base layer modulation vector is rotated toward the I-axis, the OL bit is represented by a 0. Where the OL bit is designated with an ‘x’, there is no rotation performed and therefore there is no overlay modulation. As shown in this example, for every two base layer bits transmitted, an additional bit can be overlaid onto the base layer. Constellation (b) illustrates an amplitude modulation technique for overlaying the additional bits over the base layer modulated QPSK constellation. In this method, the overlay bit is determined by comparing the amplitude of the received vector with a reference amplitude. As shown, if the transmitted vector is produced with reduced amplitude scaling, the OL bit is designated as a 1, and if the transmitted vector is produced with increased amplitude scaling, the OL bit is designated as a 0. If there is no determined amplitude scaling with respect to a reference amplitude, there is no additional information overlaid onto the base layer. Other forms of hierarchical modulation are known, each providing some trade-off in the robustness of the received signal for both the base layer and the hierarchical/overlay layer in consideration of the transmission channel effects.

Hierarchical modulation and demodulation is available in some fixed environments such as satellite and terrestrial systems. For example, the Digital Video Broadcasting specification for terrestrial signaling (i.e., DVB-T) in Europe provides two separate data streams modulated onto a single DVB-T stream. One stream, called the “High Priority” (HP) stream is embedded within a “Low Priority” (LP) stream. Receivers with “good” reception conditions can receive both streams, while those with poorer reception conditions may only receive the “High Priority” stream. Broadcasters can target two different types of DVB-T receivers with two completely different services. In the DVB-T example, the single DVB-T stream can be described as transporting two pipes, that is, two different pipes having respective forward error correction (FEC) coding. The DVB-T system utilizes a single pipe for the “Low Priority” stream and a single pipe for the “High Priority” stream. The DVB-T system is a flexible system that allows terrestrial broadcasters to choose from different encoding options to suit their various service environments and generally enables such broadcasters to trade-off bit-rate versus signal robustness.

DVB-T and similar hierarchically modulated systems do not contemplate diversity system receivers such as SDARS receivers which can demodulate and decode broadcast streams from multiple transmission sources such as first and second satellite streams broadcast from first and second satellites for time and spatial diversity purposes and/or terrestrial broadcast streams (e.g., from such terrestrial transmission sources as terrestrial repeaters, paging systems and/or cellular systems) employed to overcome the afore-mentioned LOS issues and other signal loss issues. A need exists for an enhanced, next generation SDARS system or other broadcast system implementing time, space and/or code diversity that can similarly provide a plurality of separate data streams onto a single transmitted stream for targeting different receivers in a time and/or space and/or code diversity environment, and/or providing different services and different quality of services. Moreover, it is desirable to provide an enhanced SDARS system or other diversity system that does not affect the performance of legacy receivers, while providing the additional services to enhanced, next generation receivers.

The additional data capacity realized by improved or enhanced hierarchical modulation techniques can provide unique opportunities to enhance legacy SDARS services or other legacy broadcast services of systems that transmit data using diversity streams. In other words, a need also exists for an improved hierarchical modulation for a diversity system that employs multiple pipes in the overlay layer and uses different combinations of diversity signals or subsets of diversity signals (e.g., selected from two satellite data streams and a terrestrial data stream) in the respective pipes.

In addition, a need exists to dynamically reconfigure pipes within a multiple pipe broadcast system (e.g., the allocations of different combinations of diversity signals or subsets of diversity signals among the respective pipes) and to control receivers (e.g., satellite signals receivers at terrestrial repeaters or user receivers) to dynamically change the error decoding required for the various pipe configurations to the decoding required for a different pipe configuration.

### SUMMARY OF EMBODIMENTS OF THE INVENTION

Illustrative embodiments of the present invention address at least the above problems and/or disadvantages and provide at least the advantages described below.

Accordingly, a first illustrative embodiment of the present invention provides a method of transmitting a plurality of services in a communication system. The method in this embodiment signals data identifying a first parameter and a second parameter related to respective pipe configurations for processing first and second services, respectively, wherein the pipe configurations correspond to respective data streams having defined reception characteristics and that are transported within a common broadcast stream. The bit-stream of each of the first and second services is then processed according to their respective parameter. The first and second services and the signaling data are multiplexed together in a single frame, modulated and then transmitted to a receiver or terrestrial repeater.

A second illustrative embodiment of the present invention provides a method of receiving a plurality of services in a communication system. The method according to this embodiment demodulates and demultiplexes a received frame including first and second services. Signaling data received in the frame is then determined, wherein the signaling data identifies a first parameter and a second parameter related to respective pipe configurations for processing first and second received services, respectively. The receiver then processes the received bit-stream of each of the first and second services according to their respective parameters identified in the signaling data.

A third illustrative embodiment provides a method of reconfiguring a pipe configuration in a communication system. The method in this embodiment transmits first and second services encoded according to respective pipe configurations of each service as identified in a first signaling pipe that includes information identifying a first parameter and a second parameter related to the respective pipe configurations for processing the first and second services, respectively. A reconfiguration flag in a second signaling pipe is set to indicate a reconfiguration process and the second signaling pipe including at least one reconfigured parameter is transmitted with first and second services according to the first signaling pipe for a period of time. When the reconfiguration flag in the second signaling pipe is set to indicate an end of the reconfiguration process, the first and second services are encoded according to the second signaling pipe and transmitted.

In another illustrative embodiment, a method of reconfiguring a pipe configuration in a communication system receives first and second services encoded according to respective pipe configurations of each service as identified in a first signaling pipe that includes information identifying a first parameter and a second parameter related to the respective pipe configurations for decoding the first and second services, respectively. When it is determined that a reconfiguration flag in a second received signaling pipe including at least one reconfigured parameter indicates a reconfiguration process, the first and second services are still decoded according to the first signaling pipe for a period of time until it is determined that the reconfiguration flag indicates an end of the reconfiguration process. The first and second services are then decoded according to the second signaling pipe.

Objects, advantages and salient features of the invention will become apparent to those skilled in the art from the following detailed description, which, taken in conjunction with annexed drawings, discloses illustrative embodiments of the invention.

### BRIEF DESCRIPTION OF THE DRAWINGS

The above and other illustrative features and advantages of certain illustrative embodiments of the present invention will become more apparent from the following description of certain illustrative embodiments thereof when taken in conjunction with the accompanying drawings in which:

FIG. 1 illustrates a satellite digital audio radio system according to an illustrative embodiment of the present invention.

FIGS. 2a and 2b illustrate example constellations demonstrating the concepts of hierarchical modulation.

FIG. 3a illustrates a system architecture of a hierarchical modulation system according to an illustrative embodiment of the present invention.

FIG. 3b is a block diagram of the layer structure of a hierarchical modulation system according to an illustrative embodiment of the present invention.

FIG. 4 illustrates a pipe configuration and multiplexing structure of an overlay layer according to an illustrative embodiment of the present invention.

FIG. 5 illustrates an example pipe configuration according to an illustrative embodiment of the present invention.

FIG. 6 illustrates example diversity configurations for the data pipes across each of the satellite and terrestrial streams according to an illustrative embodiment of the present invention.

FIG. 7 is a timing diagram of the pipe reconfiguration process according to an illustrative embodiment of the present invention.

FIG. 8 depicts a block diagram of a receiver according to an illustrative embodiment of the present invention.

FIG. 9 is a flowchart illustrating a method for transmitting a plurality of services in a communication system according to an illustrative embodiment of the present invention.

FIG. 10 is a flowchart illustrating a method for receiving a plurality of services in a communication system according to an illustrative embodiment of the present invention.

FIG. 11 is a flowchart illustrating a method for reconfiguring a pipe configuration in a communication system according to an illustrative embodiment of the present invention.

Throughout the drawings, like reference numerals will be understood to refer to like elements, features and structures.

### DETAILED DESCRIPTION OF ILLUSTRATIVE EMBODIMENTS

The following description is provided to assist in a comprehensive understanding of illustrative embodiments of the invention of the present disclosure with reference to the accompanying figures. Accordingly, those of ordinary skill in the art will recognize that various changes and modifications of the illustrative embodiments described herein can be made without departing from the scope and spirit of the claimed invention. Also, descriptions of well-known functions and constructions are omitted for clarity and conciseness.

In accordance with an illustrative embodiment of the present invention, a Satellite Digital Audio Radio Service (SDARS) system 10 is enhanced with a hierarchically modulated data stream (hereinafter referred to as “an overlay data stream”) that is overlaid on a base layer (legacy) data stream. It is to be understood, however, that the illustrative embodiment of the present invention can be implemented in other types of diversity systems (e.g., a system that employs plural transmission streams from one or more of cellular, paging, microwave or other modes of wireless broadcast communication for diversity purposes or other purposes). The addition of hierarchical modulation to an SDARS system significantly increases the amount of data and services transmitted via the SDARS system. Using improved (next generation) receiver designs, additional services can be provided to users while existing legacy receivers can continue to receive the services broadcast on the base layer modulated data stream in the legacy system.

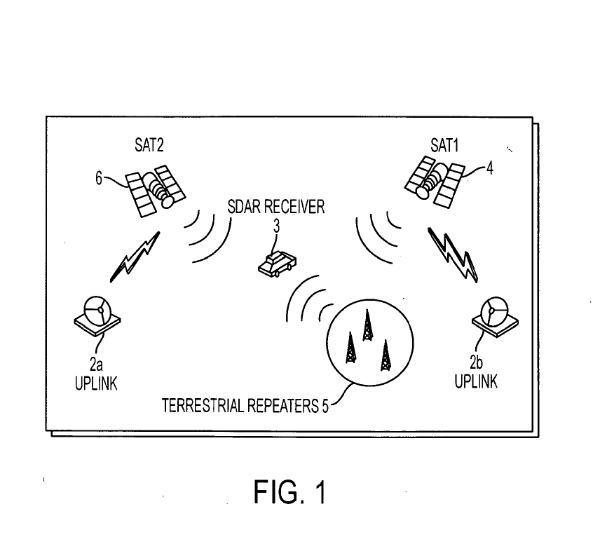

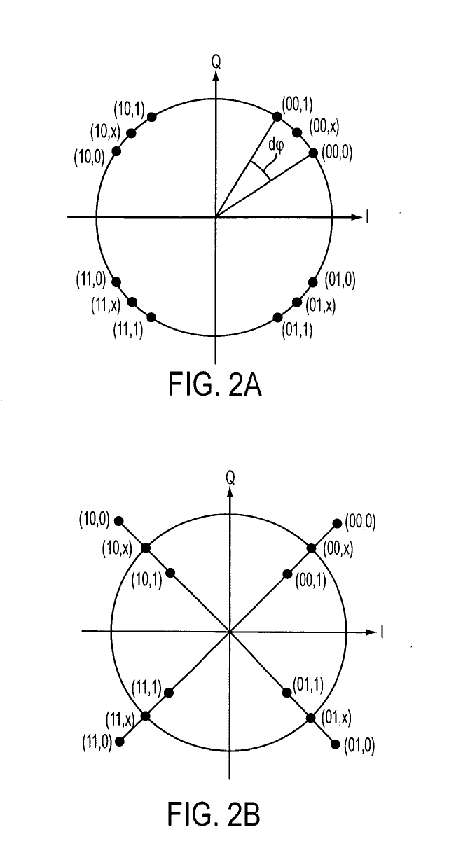

An illustrative Sirius XM Radio Inc. hierarchical modulation system (XMH) uses substantially the same general infrastructure as the XM SDARS system shown in FIG. 1 as described in the background. The uplink transmitter(s) 2a, 2b, SAT1 4, SAT2 6, terrestrial repeaters 5 and receivers 3, however, are modified to include additional capability and functionality to receive, transmit, modulate and demodulate, respectively, the hierarchical modulated stream that is overlaid on the base layer stream of the legacy system. See, for example, U.S. Pat. Nos. 7,778,335, 6,154,452, 6,229,824, 6,510,317, and 6,724,827, which are incorporated by reference herein in their entirety.

Referring back to FIG. 1, the uplink stations 2a and 2b in an illustrative XMH system provide both a base layer (legacy) data stream, and an overlay (hierarchically modulated) data stream as a combined data stream. In an illustrative embodiment, the overlay stream and the base layer stream are synchronized together, as further discussed below and in the commonly assigned co-pending application titled “Method of Improving Performance in a Hierarchical Modulation System” filed on even date herewith (Attorney Docket No. 55870), which is incorporated by reference herein in its entirety. The overlay data stream is preferably added to the base layer stream in a backward compatible way, so that legacy receivers can still receive the base layer stream. As in the legacy system, the uplink stations 2a, 2b provide the combined, hierarchically modulated data stream to at least one of the satellites SAT1 4 and SAT2 6 via an RF transmission link. Satellites 4 and 6 retransmit the combined data stream to a plurality of subscribers for reception via either fixed or mobile SDARS receivers 3. An illustrative frequency plan of the XMH system is the same as that described in U.S. Pat. Nos. 6,510,317 and 6,724,827, which are incorporated by reference herein in their entireties. As described in U.S. Pat. No. 6,154,452, which is incorporated by reference herein in its entirety, a receiver 3 comprises receiver arms for each of the satellite and terrestrial signals it receives. The receiver arms are configured to synchronize the frames of the received signals during demodulation and decoding to allow for diversity combining of the signals as needed.

In an illustrative embodiment, the terrestrial repeaters 5 receive the radio frequency carrier from at least one of the satellites SAT1 4 or SAT2 6. The content received at the repeaters 5 is retransmitted at a different S-band carrier to the subscribers that are within their respective coverage areas via a transmit antenna. The repeaters 5 are configured to demodulate the hierarchically modulated data to extract the overlay layer from the combined data stream and re-modulate the stream using a terrestrial modulation scheme such as multi-carrier modulation. The SDARS receivers 3 are designed to receive one or more of the satellite signals and the signals from the terrestrial repeaters and combine or select one of the signals as the receiver output. In addition, the combination of the three signals from the two satellite signals and the terrestrial signals can be diversity combined to improve reception performance. See, for example, U.S. Pat. Nos. 6,154,452, 6,229,824, and 6,823,169, which are incorporated by reference herein in their entireties.

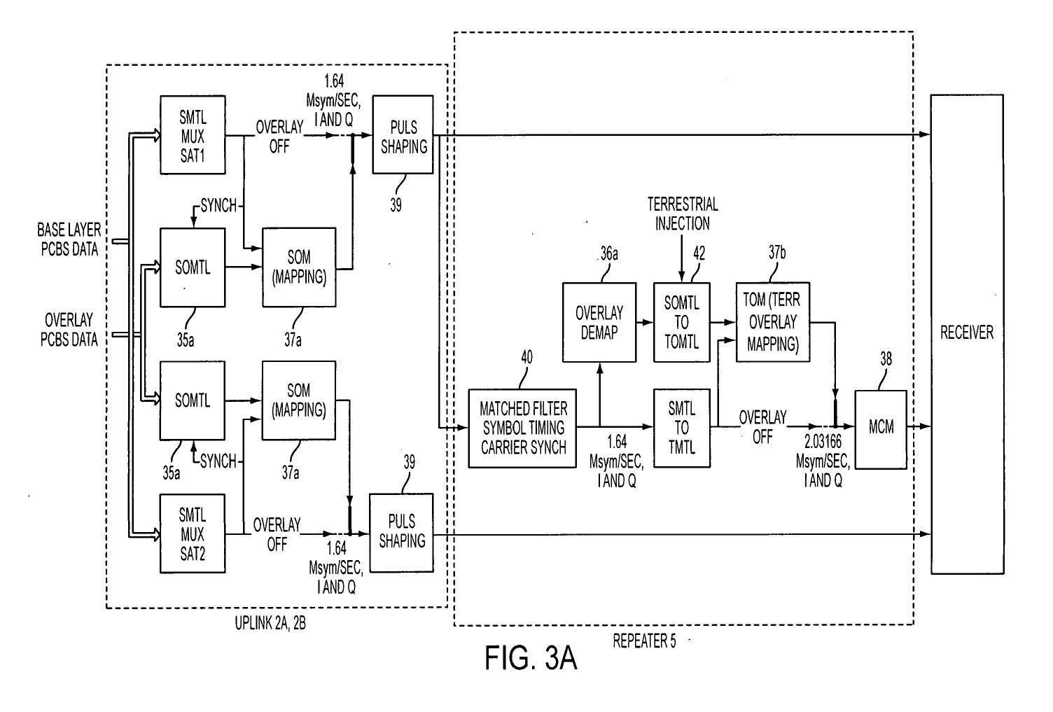

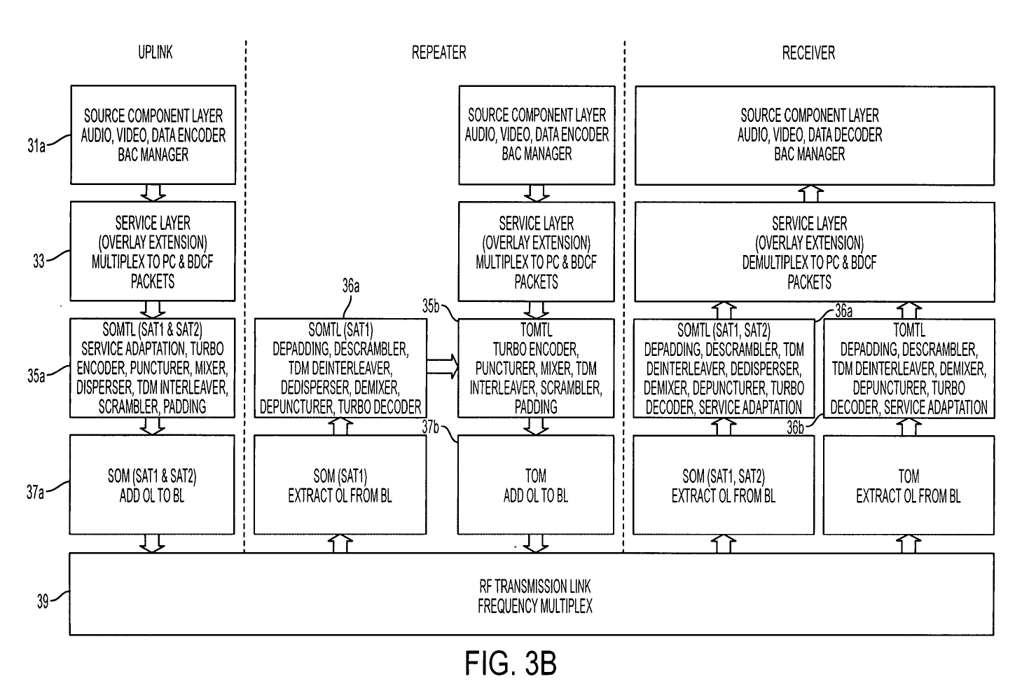

FIG. 3a illustrates a system architecture of an exemplary XMH system. For illustrative purposes, the function blocks specific to the overlay system at an uplink station 2a, 2b, and at a terrestrial repeater 5 are shaded in FIG. 3a, and the function blocks specific to the base layer system are not shaded. With regard to the base layer system, the XMH comprises satellite multiplex transport layer (SMTL) multiplexers (MUX) and pulse shaping modules for each of the satellite signals at an uplink station. See, for example, U.S. Pat. No. 6,564,003, which is incorporated by reference herein in its entirety and describes a service layer and transport layer of an illustrative base layer. With regard to the overlay system, the XMH includes at least one satellite overlay multiplex transport layer (SOMTL) module 35a. Two SOMTL modules are shown, one for each of SAT1 and SAT2. The SOMTL modules 35a receive payload channel data from a plurality of service providers and adapt the payload channels to the transport layer as payload channel packets (PCPs) and payload channel fragments (PCFs). The SOMTL modules 35a also function to encode the payload channels and output a time-division multiplexed (TDM) bit-stream. Additional functionality of the SOMTL modules 35a is discussed further below with respect to FIG. 4. The illustrative XMH system also includes satellite overlay multiplex mapping (SOM) modules 37a for mapping the overlay data to the base layer data. The pulse shaping modules 39 modulate the combined data for transmission on the physical RF transmission link to SAT1 4 and SAT2 6. The SOMTL modules 35a and the SOM modules 37a can reside, for example, at an uplink station 2a, 2b along with the base layer modules. It is to be understood that the modules depicted in FIG. 3a can be implemented in hardware, software or a combination of both.

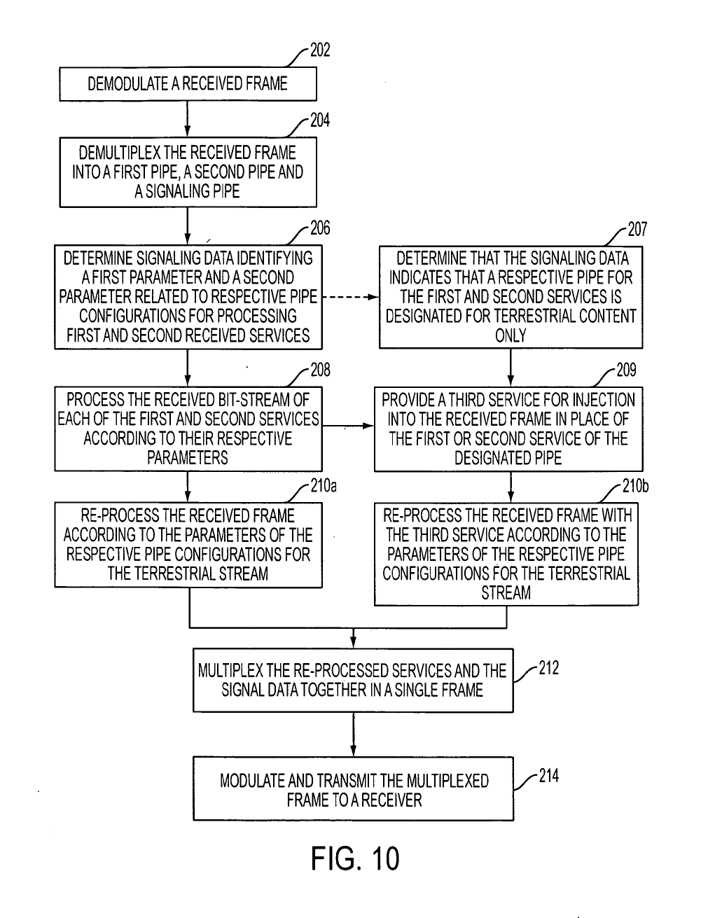

With continued reference to FIG. 3a and with regard to base layer processing (e.g., unshaded modules in FIG. 3a), the terrestrial repeaters 5 can be provided with a matched filter/symbol timing and carrier synchronization module 40 and an SMTL to terrestrial multiplex transport layer (TMTL) module 42 for demodulating, synchronizing and re-formatting the received waveform from the satellite(s) into a terrestrial waveform that is, in turn, provided to a multiple carrier modulator (MCM) module 38. See, for example, U.S. Pat. Nos. 6,510,317 and 6,785,565, which are incorporated by reference herein, for an illustrative description of terrestrial repeater waveform processing and transmission. With regard to the overlay processing, each of the terrestrial repeaters 5 can also include an overlay decoding/demapping module 36a to undo the encoding and other processes performed by the SOMTL modules 35a, so that the decoded payload channel data can be re-encoded using parameters designated for the terrestrial data stream (Steps 202, 204, 206, 208, 210a, and 212 in FIG. 10). This functionality is performed in the terrestrial overlay multiplex transport layer (TOMTL) module 35b. As discussed further below, the TOMTL module 35b is also capable of injecting additional content into the payload channel data for transmission to the plurality of SDARS receivers 5 (Steps 207, 209, 210(b) in FIG. 10). The additional content may include any additional information. For example, the additional content can be specific to a localized area (e.g., local news, weather forecasts, advertisements and the like). The terrestrial overlay multiplex layer (TOM) block 37b is provided to map the overlay data to the base layer data. The multi-carrier modulation module 38 then modulates the terrestrial data onto the physical RF transmission link (Step 214).

FIG. 3b illustrates a layer structure of a hierarchical modulation system (XMH) according to an illustrative embodiment shown in FIG. 3a. As discussed above, an illustrative overlay waveform provided at the uplink station 2a, 2b consists of a source component layer 31a, a service layer 33, a satellite overlay multiplex transport layer (SOMTL) 35a, and a satellite overlay multiplex physical layer (SOM) 37a, and the physical RF transmission link 39.

Like the legacy XM SDARS system, the source component layer comprises bit-streams containing audio, video, data or other information from a plurality of service providers. The basic input and output of the overlay system is a Payload Channel (PC). A PC is a transport mechanism used to carry one or more service components carrying the audio, video, speech, and certain types of associated data. The service layer 33 defines the contents of the PC including the types of service components contained in the PCs. A PC comprises a multiplex of up to 16 service components contained within several payload channel packets, preferably of 446 bytes each. The structure of the payload channel is the same as that used in the legacy XM system, the scope of which is beyond the present disclosure. See, for example, U.S. Pat. Nos. 7,809,326, 7,180,917, 6,347,216, 6,876,835, and 6,686,880, which are incorporated by reference herein in their entireties. The service layer provides the PCs to the transport layer, as well as a unique 8 bit payload channel identifier (PCID) for each of the PCs provided to the SOMTL module 35a.

The transport layer in an illustrative embodiment generally serves to define any Forward Error Correction (FEC) encoding, an interleaving structure and a multiplexing structure of a transport ensemble containing up to 256 PCs. The output of the transport layer is a time-division multiplexed (TDM) bit-stream. The illustrative XMH system comprises enhanced SOMTL 35a and TOMTL 35b processing modules for preparing the overlay data to be mapped to base layer data.

FIG. 4 illustrates an illustrative multiplexing structure of the overlay system performed in the SOMTL 35a modules and the TOMTL 35b modules. The overall functionality of the SOMTL and the TOMTL modules are nearly identical and generate similar waveforms as discussed further below. The TOMTL waveform, however, provides additional capacity that is not required for retransmitting the content of the satellite signal. In an illustrative embodiment, this additional capacity amounts to 128 IUs, which may be used to inject additional terrestrial content.

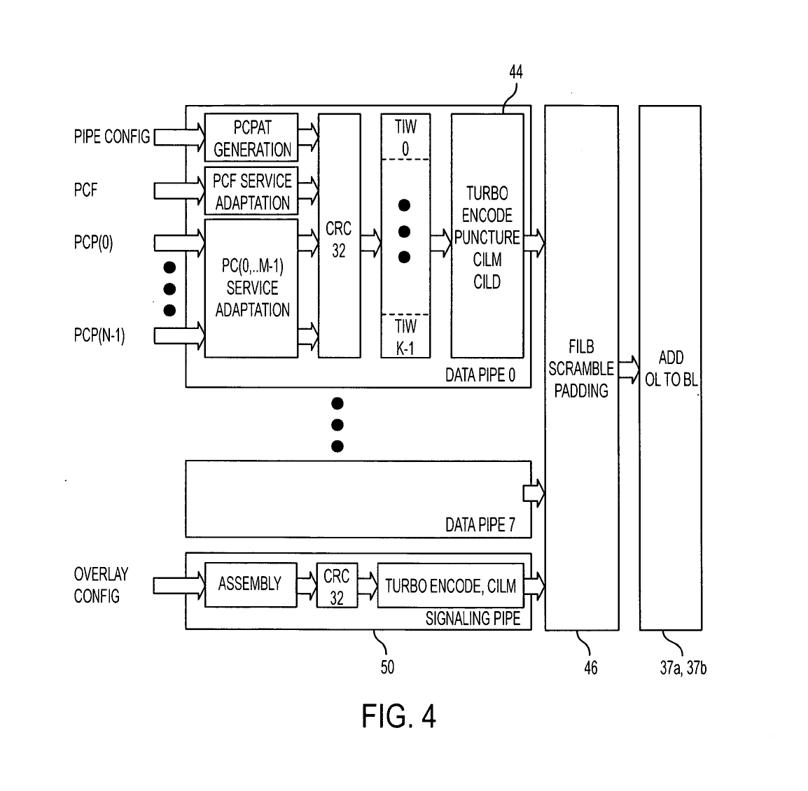

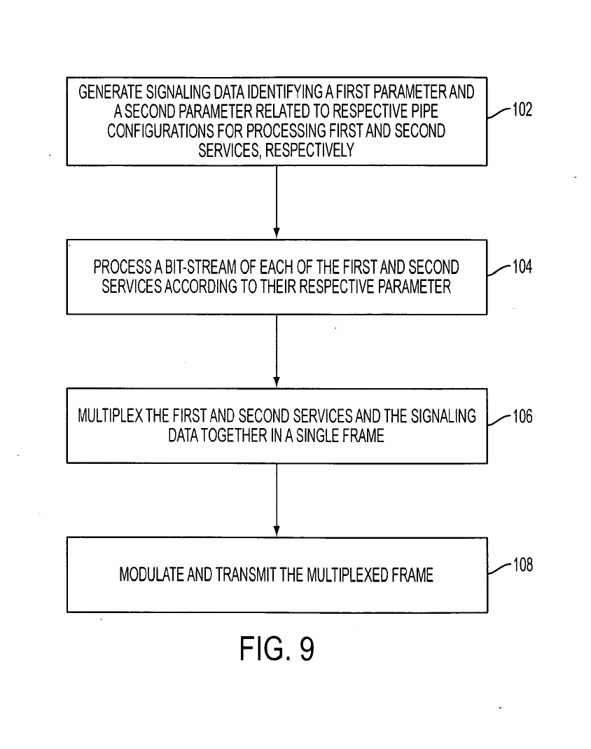

With reference to FIG. 5, and in accordance with an illustrative embodiment of the present invention, the overlay data is spread between up to 8 unique data pipes (e.g., pipe 0, pipe 1, . . . pipe 7) per ensemble, numbered from 0 to 7, and an additional common signaling pipe 50. A data pipe in the illustrative embodiment is a unique subset of a master frame transmitted in an XMH system. Each data pipe has a unique configuration that corresponds to respective data streams having defined reception characteristics within a common broadcast stream (Step 102, 104 in FIG. 9). A data pipe is defined by a reserved size in number of Turbo Input Codewords (TIWs) less than the total number of TIWs per master frame of overlay data. Additionally, each data pipe may utilize a unique code rate and interleaver structure, as discussed below. While the illustrative embodiment is described as using 8 different pipes, any number of pipes may be used according to the desired services to be provided. As discussed further below, the data provided in each pipe can be unique to each stream, i.e. SAT1, SAT2 and terrestrial. The signaling pipe 50, however, is common for all streams and carries the data pipe multiplex structure of the transport layer for each stream. The signaling pipe comprises a description of each of the data pipes and their configuration for each of the streams. The signaling pipe is used within a decoder at a receiver or repeater to decode the overlay stream from each of the received streams. The position, the size and all decoding parameters of the signaling pipe are generally constant and are not configurable, except during a reconfiguration discussed further below. Therefore, the content of the signaling pipe can generally be considered as static for the receiver operation.

Each data pipe has unique content and may be transported by any combination of SAT1, SAT2 and the terrestrial repeater, that is, any combination of diversity transport methods employed in a diversity system. A stream does not necessarily transmit all data pipes and, moreover, the transport layer configuration, e.g. the code-rate etc., for each pipe may differ between each of the streams. In an illustrative embodiment, it is not necessary to fill each data pipe with service data as one or more of the data pipes may be empty.

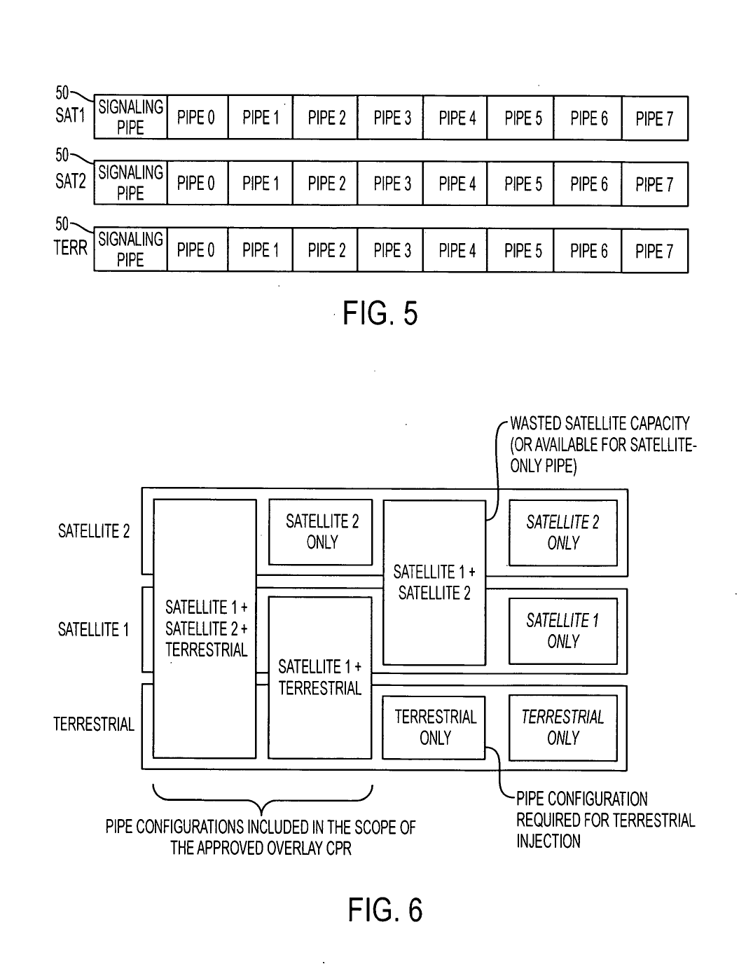

FIG. 6 illustrates an illustrative diversity configuration of the data pipes provided in an illustrative XMH overlay stream. For example, in an illustrative embodiment, there may be a pipe or pipes designated for injection of terrestrial content only that is not transmitted in the satellite streams and vice versa. In such an embodiment, the terrestrial repeater is configured to extract the signaling pipe from the received overlay data stream. Upon determining that one of the terrestrial stream pipes is designated for terrestrial content only, the terrestrial repeater ignores any received data contained within the designated pipe and functions to inject additional local content in the designated pipe (Steps 207, 209 in FIG. 10). Only those receivers in the broadcast area of the terrestrial repeater are enabled to receive the locally injected content. Such local content may include some form of advertisement or local service including broadcast data unique to the local area, such as weather or traffic alerts.

In another illustrative embodiment, regional information can be designated for transmission on only SAT1 or SAT2. In other words, a pipe may be designated for transmission on only one of SAT1 and SAT2. Accordingly, only those receivers in the line of sight of either SAT1 or SAT2 will receive a specific service. In yet another illustrative embodiment, a number of data pipes may be designated with conditional access, so that only those receivers authorized to decode the conditional access data pipes are capable of receiving the services transmitted thereon. Such conditional access may be based on selected service packages provided for a premium, as well as particular receivers of a service class or country. For instance, the data pipes may be configured to provide service data specific to an international market, such as Mexico or Canada. The international market repeaters are configured to ignore those pipes not designated for Mexico or Canada and inject local content on the pipes instead.

In the above illustrative embodiments, the local content desired for injection, is sent to an uplink facility by a local service provider through some backhaul channel. The uplink facility formats the local content and distributes the content to local markets through another distribution network, such as KU-band via VSAT receiver dishes based at the local repeater site. The local content can then be injected onto any pipe designated for the service. Alternatively, in an illustrative embodiment, a secondary signaling pipe can also be injected directly at the receiver to override the globally broadcasted signaling pipe to allow for a unique local configuration. Bandwidth allocated for global satellite content can then be replaced, allowing for reception of locally injected terrestrial content using the unique local configuration. In this example, a pipe that is set for diversity combining across all three signals can be modified in the receiver to be based on the terrestrial broadcast signal only.

Any number of scenarios can be realized for using the pipe configurations of the overlay data, as described above, to provide enhanced functionality of the SDARS system. The range of services capable of being realized is not limited to the above description. Many unique service arrangements can be provided in accordance with a desired service, as would be evident to one of ordinary skill in the art. It is desirable to optimize the broadcast availability of each service type by adjusting the FEC rate, interleaver structure, and diversity combining profile of each pipe to maximize the throughput of the service for a given quality of service desired.

The following table (Table 1) describes the content of the signaling pipe used to receive each of the data pipes transmitted in each of the streams. As can be seen, there are 26 global bits and 40 bits per pipe defined. As discussed further below, there is also an additional 32 bit CRC field appended at the end of the signaling pipe. The 4 bit TerrCodeID, SAT1CodeID and SAT2CodeID define the forward error correction (FEC) and mixer scheme selected for each stream in the pipe.

TABLE 1

| Field | Width [bit] | Remarks |
|---|---|---|
| VersionID | 2 | currently 0 |
| ReconfFlag | 1 | set to ‘1’ during reconfiguration |
| RFU | 23 | 0x000000 |
| Per Pipe | Per Pipe | Per Pipe |
| Size | 5 | size of pipe in number of turboblocks |
| | | (TIW) |
| SatDisperserNLT | 4 | dedisperser Number of Late Taps, |
| SatDisperserDILT | 6 | dedisperser Delay Increment of Late |
| | | Taps Format: 3 bit integral part, 3 bit |
| | | fractional part |
| SatDisperserDIUT | 8 | dedisperser Delay Increment of |
| | | Uniform Taps Format: 5 bit integral |
| | | part, 3 bit fractional part |
| Sat2DisperserMode | 1 | dedisperser mode for Sat2 wrt Sat1 |
| | | Disperser |
| | | 0: flip the tap delays of Sat1 |
| | | 1: half cyclic shift the tap delays of |
| | | Sat1 |
| TerrCodeID | 4 | selected code configuration for terr |
| Sat1CodeID | 4 | selected code configuration for sat1 |
| Sat2CodeID | 4 | selected code configuration for sat2 |
| StreamMode | 3 | bit 0 set to ‘1’ if pipe is distributed |
| | | over Terrestrial |
| | | bit 1 set to ‘1’ if pipe is distributed |
| | | over Satellite 1 |
| | | bit 2 set to ‘1’ if pipe is distributed |
| | | over Satellite 2 |
| FragPaddMode | 1 | ‘0’: PRC format |
| | | ‘1’: BDC format |

As discussed above, the signaling pipe 50 is generally static, however, in an illustrative embodiment, the signaling pipe is reconfigured at the uplink to provide additional or modified services. Dynamic reconfiguration may be useful for establishing a special service for a limited amount of time or to provide special broadcasting of an athletic event or some other event. In accordance with an illustrative embodiment of the present invention, dynamic re-configuration of the network is provided via the signaling pipe 50 though the use of a reconfiguration flag, for example, that provides a forward looking indication that a reconfiguration is in process.

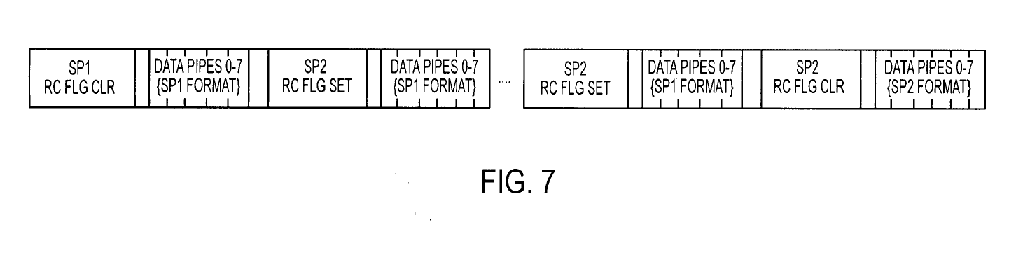

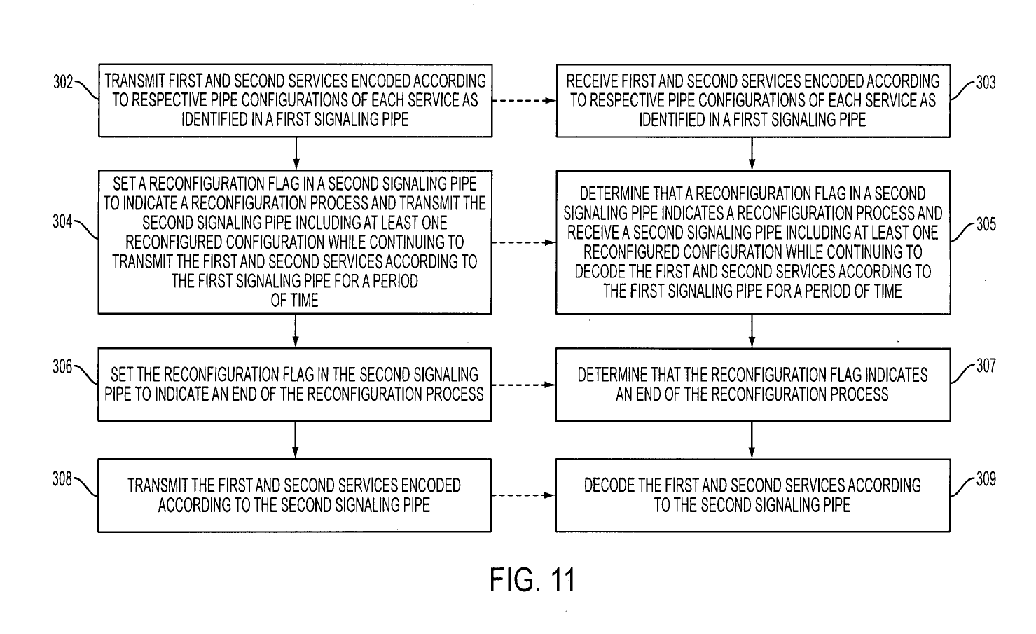

FIG. 7 and FIG. 11 illustrate the timing of a reconfiguration process according to an illustrative embodiment. If it is determined that the data pipes are to be reconfigured, a new signaling pipe (SP2) is generated with the reconfigured parameters (Step 304). During the reconfiguration, the uplink is free to choose any strategy to set up the overlay system again. A ReconfFlag (RC FLG) of the new signaling pipe SP2 is set to ‘1’. The transmitter continues to transmit the data pipes according to the previous signaling pipe (SP1) (Step 302). When the terrestrial repeater, which is receiving the satellite signal for transcoding to the terrestrial broadcast, or the receiver identifies that a reconfiguration flag in the new signaling pipe SP2 is set to ‘1’, the terrestrial repeater or receiver receives the new signaling pipe information in SP2 and prepares to modify its decoders to process the new configuration in the future. To prevent any service interruption at the uplink, once the receiver notices the ReconfFlag is set to ‘1’, it begins to receive the new configuration information while continuing to receive and output the received data using the current configurations in SP1 (Steps 303, 305). When the ReconfFlag is cleared or set to ‘0’, the repeaters and the receivers load the new configuration of SP2 into their decoders and transcoders and begin decoding and transcoding the received data using the new configuration of SP2 (Steps 306, 308 and 307, 309).

The signaling pipe preferably uses a minimum bandwidth and allows a very fast decoding after startup in order to minimize the overall receiver startup time. Accordingly, in the illustrative embodiment, the signaling pipe is not dispersed over a period of time, but is instead interleaved over 1 TDM frame using a fixed position inside the TDM frame. For example, the signaling pipe 50 comprises 7 interleaver units (IUs), discussed further below, that are multiplexed with a plurality of data pipes within a master frame. The 7 IUs comprising the signaling pipe are preferably separated by an equal distance within a master frame. To improve reception of the signaling pipe during reconfiguration, the ReconfFlag may be set to ‘1’ over a span of several TDM frames. The ReconfFlag prevents any confusion as to when to begin using the new configurations, and thus prevents any service interruption.

Referring back to FIG. 4, the service layer data received from a service provider at an uplink facility or data received for terrestrial injection are first adapted to payload channel packets (PCPs) and payload channel fragments (PCFs). The PCFs are payload channels that include broadcast data channel fragment (BDCF) or prime rate channel fragment (PRCF) data fields without service content. The overlay content is mapped to up to 8 different pipes, as shown. Each pipe is able to carry several PCPs and a PCF as data. Each of the M different payload channels for each pipe consists of one or more payload channel packets, so there are N different payload channel packets at the input for each pipe configuration (Steps 102, 104 in FIG. 9).

The incoming PCF and PCPs from the service layer are first adapted to the transport layer as discussed above. After service adaptation, the PCPs and PCF packets become transport payload channel fragment (TPCF) and transport payload channel packets (TPCPs). For the PCP, the bits that are not transported, are removed. For example, for each PCP, the service adaptation function may drop a service preamble and part of an auxiliary data field, thus omitting up to 48 bits for each PCP. If the number of PCPs received from the service layer is less than the allotted number of PCPs to fill the pipe, empty TPCPs having all zero content may be inserted. For the PCF, padding bits are inserted to fill up the remaining space in each pipe. The number of PCPs per pipe and the size of the PCF are a function of K, the length of the pipe in number of turbo input words (TIWs), which are the basic input blocks for a turbo encoder.

A PCP allocation table (PCPAT) is added for each data pipe. For the PCF packet and each of the PCPs, the PCPAT field carries the information for mapping to the payload channels. The PCPAT table comprises payload channel identifiers (PCIDs) of the PCF and the PCPs in the order of their allocation, i.e. location within the data pipe. The PCPAT field preferably comprises an 8 bit PCID entry for the TPCF and every TPCP. The PCIDs are supplied by the service layer and are used to identify one of the 256 different payload channels input to the transport layer. Accordingly, the PCPAT is generated dynamically for each data pipe in the output TDM frame.

As shown and described below in accordance with the illustrative embodiment, a 32 bit cyclic redundancy check (CRC) field is calculated and inserted in each data pipe and signaling pipe. There is preferably one CRC32 field for each PCP. For the PCPAT and the PCF, a common CRC32 field may be inserted. As shown, the basic unit of the transport layer is a turbo input word (TIW). Each data pipe is designated an integer number of TIWs per TDM frame. The turbo input words are sequentially filled with the PCPAT, the TPCF and the TPCPs together with the CRC32 field. The turbo input words are then input to a turbo encoder for forward error correction coding.

The turbo encoder, provided as part of encoding module 44, encodes the input TIWs based on a desired code rate designated for the individual data pipes. The turbo encoder preferably performs a desired puncturing pattern on the output turbo encoded symbols to achieve a desired coding rate designated for the individual pipes. The non-punctured symbols comprise a plurality of turbo output words (TOWs). The TOWs are preferably then processed by a channel interleaver mixer (CILM), also provided as part of encoding module 44, which may be a block interleaver processing each TOW output from the turbo encoder. The illustrative purpose of the CILM is to reorder the bits of the TOW such that adjacent bits are spread throughout the TOW. The parameters of the interleaver are configurable and are designated in the signaling pipe for each overlay pipe. Each pipe may use a different configuration to realize a desired trade-off between capacity and interleaver delay. A channel interleaver disperser (CILD) of the encoding module 44 is also preferably provided to chop the TOWs into interleaver units (IUs). The IUs may be dispersed over a long time span by interleaving with other IUs belonging to different TDM frames. The disperser is also configurable for each pipe.

The encoded output of each of the pipes 0 to 7 and the signaling pipe consists of an integer number of interleaver units (IUs). Each pipe has its own transport layer configuration regarding the FEC and the channel interleaver. For example, the data rate, the code rate, and the interleaver parameter can be different for each of the pipes. The number of IUs for each pipe is dependent on the selected parameters and the bitrate selected for the pipe. If the used capacity of a data pipe is less than the allotted capacity, then empty IUs may be added to fill up the TDM frame. All IUs of the TDM frame are block interleaved in the frame interleaving block (FILB) 46. The FILB 46 first multiplexes the IUs to a considered stream (i.e. SAT1, SAT2, terrestrial) as indicated in the signaling pipe. The multiplexed pipes for each stream are then scrambled. The IUs are then written into a matrix row by row in ascending order of pipes. The bits are then mapped to ternary symbols (tsym) representing the overlay modulation bit. The size of the matrix is 114 rows times 32 columns for the SOMTL frame and 118 rows times 32 columns for the TOMTL frame. The IUs are read column by column to generate the respective SOMTL and TOMTL frames. The seven IUs of the signaling pipe are then multiplexed with the output of the FILB 46, each preferably separated by an equal distance within the frame (Step 106 in FIG. 9). Any necessary padding bits are added to fill the TDM frame to match a TDM frame of the base ‘layer. The resulting overlay TDM frame has a length that matches the base layer frame of 432 ms. As discussed above, the overlay layer and base layer TDM frames are preferably synchronized in time. The overlay layer is then mapped to the base layer and hierarchically modulated with the base layer data and transmitted via a radio frequency link to either an SDARS receiver or a terrestrial repeater (Step 108). Those receivers capable of demodulating and decoding the hierarchically modulated data are now able to receive a plurality of new services.

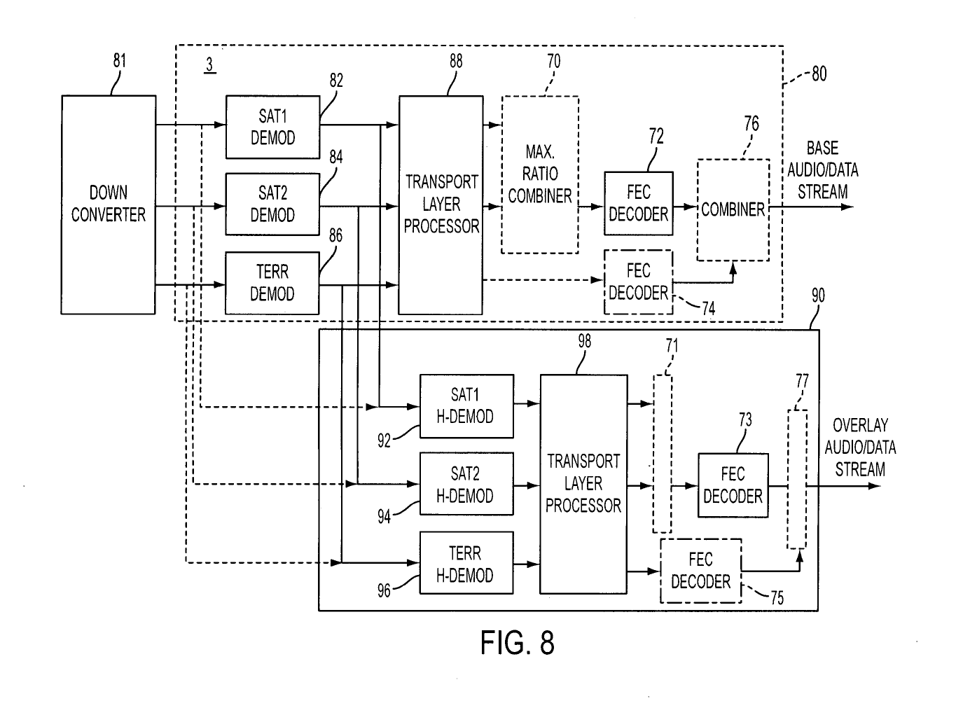

FIG. 8, depicts a block diagram of a receiver or subscriber unit 3 in accordance with an illustrative embodiment of the present invention. As discussed above, receiver 3 operationally receives two satellite (SAT1 and SAT2) and terrestrial signals, and demodulates and separates the base layer and overlay layer data streams. For both the base layer and overlay layer data streams, the two satellite and terrestrial streams can be combined (maximal ratio combining) before and/or after FEC decoding to minimize errors. In an illustrative embodiment, the combining can be performed using maximal ratio combining (before the FEC decoder) or selective combining (after the FEC decoder).

As shown in FIG. 8, the receiver 3 includes a down converter 81 for down converting the received hierarchically modulated signals of an illustrative embodiment. In existing XM Satellite Radio technology, a legacy or non-hierarchically modulated receiver system 80 typically includes a first satellite signal (SAT1) demodulator 82, a second satellite signal (SAT2) demodulator 84, and a terrestrial signal demodulator 86, for demodulating the modulated base layer. The modulated signals are further processed by a transport layer processor 88 before optionally combining the satellite signals using a maximal ratio combiner 70 and/or combining the satellite signals with the terrestrial signal using another combiner (selective combiner) 76. The receiver unit 3 further includes a FEC decoder 72 after the combiner 70 for forward error correcting the received satellite signals and a FEC decoder 74 for forward error correcting the terrestrial signal before combining with the satellite signals at the combiner 76. The resultant base layer audio/data stream is then further processed at the service layer to output the received services to a user.

In accordance with an illustrative embodiment of the present invention, the receiver unit 3 further includes a hierarchical or overlay layer processor 90 enabled to process the received signals in parallel (see dashed lines) or substantially in parallel with the processing of the base layer (legacy) audio/data stream. The overlay layer processor 90 hierarchically demodulates the received signals either before or after demodulation by the base layer demodulators 82, 84, and 86 using hierarchical demodulators 92 and 94 for the satellite signals (SAT1 and SAT2) and hierarchical demodulator 64 for the terrestrial signal. The hierarchically demodulated signals from demodulators 82, 84, 86 are further processed by a transport overlay layer processor 98 before optionally combining the satellite signals using a maximal ratio combiner 71 and/or combining the satellite signals with the terrestrial signal using another combiner (selective combiner) 77. The overlay processor preferably includes a FEC decoder 73 after the combiner 71 for forward error correcting the satellite signals and a FEC decoder 75 for forward error correcting the terrestrial signal before combining with the satellite signals at the combiner 77. The FEC decoders 73 and 75 are configured to decode the received streams according to the plurality of pipe configurations for the respective pipes in each stream, as discussed above. The base layer audio/data stream is then further processed at the service layer to output the additional overlay services to the user.

In an illustrative embodiment in accordance with the present invention, once the base layer audio/data stream and the overlay layer audio/data streams are processed, they can be provided to separate output sources if desired. For example, in an illustrative SDARS system, the base layer audio/data stream can be recorded or output in a radio unit, while the additional overlay audio/data stream can be provided to a display for viewing video data.

While the present invention has been shown and described, with reference to particular illustrative embodiments, it is not to be restricted by the illustrative embodiments but only by the appended claims and their equivalents. It is to be appreciated that those skilled in the art can change or modify the illustrative embodiments without departing from the scope and spirit of the present invention.

1. A method of transmitting a plurality of services in a communication system, the method comprising the steps of:
generating signaling data identifying a first parameter and a second parameter related to respective pipe configurations for processing first and second services, respectively, wherein the pipe configurations correspond to respective data streams having defined reception characteristics and that are transported within a common broadcast stream;
processing a bit-stream of each of the first and second services according to their respective parameter;
multiplexing the first and second services and the signaling data together in a single frame; and
modulating and transmitting the multiplexed frame.

2. The method of claim 1, wherein the communication system comprises a satellite digital audio radio system enabled to transmit the first and second services over a first satellite transmission stream, a second satellite transmission stream, and a terrestrial repeater transmission stream.

3. The method of claim 2, wherein the first parameter and the second parameter include information of at least one of a code rate and a size of the pipe for processing the respective services.

4. The method of claim 2, wherein the first parameter and the second parameter include an indication of over which transmission streams the respective services are transmitted.

5. The method of claim 1, wherein the multiplexed frame comprises an overlay layer of services that is mapped to a base layer of services and hierarchically modulated thereon.

6. The method of claim 1, wherein the pipe configurations may be dynamically configured while transmitting the multiplexed frame.

7. A method of receiving a plurality of services in a communication system, the method comprising the steps of:
demodulating and demultiplexing a received frame;
determining signaling data identifying a first parameter and a second parameter related to respective pipe configurations for processing first and second received services, respectively, wherein the pipe configurations correspond to respective data streams having defined reception characteristics and that are transported within a common broadcast stream; and
processing the received bit-stream of each of the first and second services according to their respective parameters.

8. The method of claim 7, wherein the communication system comprises a satellite digital audio radio system including a first satellite, a second satellite, a terrestrial repeater, and a receiver.

9. The method of claim 7, wherein the received frame comprises an overlay layer of services that is mapped to a base layer of services and hierarchically modulated thereon.

10. The method of claim 7, wherein the pipe configurations may be dynamically configured while transmitting the multiplexed frame.

11. The method of claim 7, wherein the steps are performed in a satellite digital audio receiver and the first and second services provided to a user.

12. The method of claim 7, wherein the steps are performed in a terrestrial repeater, and the method further comprises:
determining that the signaling data indicates that a respective pipe for the first and second services is designated for terrestrial content only;
providing a third service for injection into the received frame in place of the first or second service of the designated pipe;
re-processing the received frame with the third service according to the parameters of the respective pipe configurations;
multiplexing the re-processed services and the signaling data together in a single frame; and
modulating and transmitting the multiplexed frame to a receiver.

13. A method of reconfiguring a pipe configuration in a communication system, the method comprising:
transmitting first and second services encoded according to respective pipe configurations of each service as identified in a first signaling pipe that includes information identifying a first parameter and a second parameter related to the respective pipe configurations for processing the first and second services, respectively, wherein the pipe configurations correspond to respective data streams having defined reception characteristics and that are transported within a common broadcast stream;
setting a reconfiguration flag in a second signaling pipe to indicate a reconfiguration process and transmitting the second signaling pipe including at least one reconfigured parameter while continuing to transmit the first and second services according to the first signaling pipe for a period of time;
setting the reconfiguration flag in the second signaling pipe to indicate an end of the reconfiguration process; and
transmitting the first and second services encoded according to the second signaling pipe.

14. A method of reconfiguring a pipe configuration in a communication system, the method comprising:
receiving first and second services encoded according to respective pipe configurations of each service as identified in a first signaling pipe that includes information identifying a first parameter and a second parameter related to the respective pipe configurations for decoding the first and second services, respectively;
determining that a reconfiguration flag in a second signaling pipe indicates a reconfiguration process and receiving a second signaling pipe including at least one reconfigured parameter while continuing to decode the first and second services according to the first signaling pipe for a period of time;
determining that the reconfiguration flag indicates an end of the reconfiguration process; and
decoding the first and second services according to the second signaling pipe.
